(19) United States
(12) Patent Application Publication
(10) Pub. No.: US 2023/0038300 A1
(43) Pub. Date: Feb. 9, 2023

(54) Masterbatch Manufacturing Method and Tire Manufacturing Method

(71) Applicant: Toyo Tire Corporation, Itami-shi (JP)

(72) Inventor: Akihito Mitsui, Itami-shi (JP)

(73) Assignee: Toyo Tire Corporation, Itami-shi (JP)

(21) Appl. No.: 17/857,458

(22) Filed: Jul. 5, 2022

(30) Foreign Application Priority Data
Jul. 30, 2021 (JP) 2021-125533

(51) Int. Cl. C08C 1/15; C08K 3/013; C08K 3/04

(52) U.S. Cl. CPC C08C 1/15; C08K 3/013; C08K 3/04

(57) ABSTRACT

A masterbatch manufacturing method comprises an operation in which at least a filler slurry and a natural rubber latex are mixed to prepare a liquid mixture, and an operation in which a coagulant is added to the liquid mixture so as to cause pH to be not less than 5.0 but less than 8.0.

### TECHNICAL FIELD

The present invention relates to a masterbatch manufacturing method and a tire manufacturing method.

### BACKGROUND ART

When manufacturing a rubber product such as a tire, wet masterbatch is sometimes used to improve filler (e.g., carbon black) dispersion characteristics or improve workability (see, for example, Patent Reference Nos. 1 through 3). Wet masterbatch may, for example, be manufactured using a procedure in which, after filler or the like is mixed with natural rubber latex, filler and rubber particles within the natural rubber latex are made to mutually coagulate, and the coagulum is compacted, dried, and plasticized. To carry out compaction, drying, and plasticization, the coagulum might, for example, be subjected to treatment in an extruder.

Use of coagulant when causing filler and rubber particles within natural rubber latex to mutually coagulate is known. With natural rubber latex such as concentrated natural rubber latex, adjustment is carried out so that pH is high, e.g., on the order of pH 9 to pH 10, so as to suppress occurrence of spontaneous coagulation. This being the case, lowering of pH by coagulant results in removal of negative charge at rubber particles (i.e., electrical repulsion between rubber particles is eliminated), permitting aggregation of rubber particles.

Where coagulant is employed, addition of coagulant until a pH of on the order of 4 is reached is typical (see, for example, Patent Reference No. 2). This is because the isoelectric point of rubber particles (or to be more precise, the isoelectric point of proteins which cover the rubber particles) in natural rubber latex is pH 4.5.

### PRIOR ART REFERENCES

### Patent References

Patent Reference No. 1: Japanese Patent Application Publication Kokai No. 2006-328135
Patent Reference No. 2: Japanese Patent Application Publication Kokai No. 2016-222765
Patent Reference No. 3: International Patent Application Japanese Translation Publication No. 2000-507892

### SUMMARY OF INVENTION

### Problem to be Solved by Invention

It should be noted that establishment of a technique such as would permit water content of the coagulum to be efficiently reduced during the operation in which the wet masterbatch is prepared is desired. This is because efficient reduction of the water content of the coagulum would lead to reduction in the amount of energy, time, and so forth that must be spent to dry the coagulum.

It is an object of the present invention to provide a masterbatch manufacturing method permitting efficient reduction in the water content of a coagulum.

### Means for Solving Problem

A masterbatch manufacturing method in accordance with the present invention, which is a means for solving such problem(s), comprises

an operation in which at least a filler slurry and a natural rubber latex are mixed to prepare a liquid mixture; and

an operation in which a coagulant is added to the liquid mixture so as to cause pH to be not less than 5.0 but less than 8.0.

Because a masterbatch manufacturing method in accordance with the present invention adopts a procedure in which a filler slurry and a natural rubber latex are mixed, and a coagulant is added to the liquid mixture, it makes it possible to cause dispersion of filler to a higher degree than would be the case were filler added to natural rubber and this kneaded in a Banbury mixer (i.e., than would be the case were dry kneading carried out).

Moreover, because coagulant is added to the liquid mixture so as to cause the pH thereof to be not less than 5.0, efficient reduction of the water content of the coagulum is made possible. This is thought to be due to the fact that adding coagulant to the liquid mixture so as to cause pH to be not less than 5.0 causes the surface properties of the coagulum to be in such state as to possess suitable tackiness for compaction and kneading (e.g., a state in which there is suitable tackiness such as will permit suppression or reduction of slippage that might otherwise occur during the compaction and kneading which is carried out by an extruder), which consequently makes effective compaction and kneading of the coagulum possible.

What is more, because coagulant is added to the liquid mixture so as to cause pH to be less than 8.0, it is possible to prevent tackiness of the coagulum from becoming excessively high, as a result of which it is possible, e.g., when the coagulum is subjected to treatment in an extruder, to prevent the inlet port of the extruder from being clogged by the coagulum.

A tire manufacturing method in accordance with the present invention comprises

an operation in which a masterbatch is prepared in accordance with a manufacturing method as described above;

an operation in which the masterbatch is used to prepare a rubber composition; and

an operation in which the rubber composition is used to prepare an unvulcanized tire.

### EMBODIMENTS FOR CARRYING OUT INVENTION

Below, description is given with respect to embodiments of the present invention.

### 1. Masterbatch Manufacturing Method

A masterbatch manufacturing method in accordance with the present embodiment comprises an operation (hereinafter sometimes referred to as “Operation A”) in which at least a filler slurry and a natural rubber latex are mixed to prepare a liquid mixture, and an operation (hereinafter sometimes referred to as “Operation B”) in which coagulant is added to the liquid mixture. Because a masterbatch manufacturing method in accordance with the present embodiment comprises Operation A and Operation B, it makes it possible to cause dispersion of filler to a higher degree than would be the case were filler added to natural rubber and this kneaded in a Banbury mixer (i.e., than would be the case were dry kneading carried out). A masterbatch manufacturing method in accordance with the present embodiment may further comprise an operation (hereinafter sometimes referred to as “Operation C”) in which the coagulum is dewatered.

1.1. Operation a (Operation in which Liquid Mixture is Prepared)

At Operation A, at least a filler slurry and a natural rubber latex are mixed to prepare a liquid mixture.

Operation A may comprise an operation (hereinafter sometimes referred to as “Operation A1”) in which one of filler slurry and natural rubber latex is added to the other, and an operation (hereinafter sometimes referred to as “Operation A2”) in which this is agitated while being heated.

1.1.1. Operation A1 (Operation in which One of Filler Slurry and Natural Rubber Latex is Added to the Other)

At Operation A1, one of filler slurry and natural rubber latex is added to the other. That is, filler slurry and natural rubber latex are combined. In accordance with a method in which one of filler slurry and natural rubber latex is added to the other, the other may be added to the one as the one is agitated. For example, natural rubber latex might be added to filler slurry as filler slurry is agitated. Conversely, filler slurry may be added to natural rubber latex as natural rubber latex is agitated. In accordance with a method in which one of filler slurry and natural rubber latex is added to the other, flow of one (e.g., flow of filler slurry) may be combined with flow of the other (e.g., flow of natural rubber latex). Incidentally, to add one to the other, one may be made to collide with the other at less than 370 m/s; e.g., at not greater than 360 m/s. Of course, these may be made to collide at 370 m/s or greater. Note that agitation may be carried out after one has been added to the other.

The filler slurry may contain filler and water. The filler slurry may be obtained by adding filler to water and subjecting this to agitation. During agitation, a disperser—e.g., a high-shear mixer, homomixer, ball mill, bead mill, high-pressure homogenizer, ultrasonic homogenizer, colloid mill, and/or the like—may be used. Where necessary, the filler slurry may contain any of various other additives, e.g., organic solvents and surface active agents.

As filler, carbon black, silica, clay, talc, calcium carbonate, magnesium carbonate, aluminum hydroxide, zeolite, and mica (isinglass) may be cited as examples. One or any desired combination may be chosen from thereamong and used. It is preferred that at least carbon black be employed as filler.

As examples of carbon black, besides SAF, ISAF, HAF, FEF, GPF, and/or other such furnace blacks, acetylene black, Ketchen black, and/or other such electrically conductive carbon blacks may be used. The carbon black may be nongranulated carbon black or may be granulated carbon black that has been granulated based upon considerations related to the handling characteristics thereof. Any one thereamong may be used, or any two or more thereamong may be used.

Where the filler slurry contains carbon black, the amount of carbon black in the filler slurry might, for example, be not less than 20 mass %, might be not less than 40 mass %, might be not less than 60 mass %, might be not less than 80 mass %, or might be 100 mass %, per 100 mass % of filler within the filler slurry.

Hereinbelow, note that filler slurry which contains carbon black is sometimes referred to as carbon black slurry. A carbon black slurry may contain, together with carbon black, filler other than carbon black.

As natural rubber latex, concentrated natural rubber latex and field latex may be cited as examples. Where necessary, these may be used in diluted form. In the natural rubber latex, rubber particles may be dispersed in colloidal fashion in dispersion medium. More specifically, in the natural rubber latex, rubber particles may be dispersed in colloidal fashion in water. The natural rubber latex may contain organic solvent. Thus, the dispersion medium might, for example, be water that contains organic solvent.

It is preferred that dry rubber content of the natural rubber latex be not less than 10 mass %, and more preferred that this be not less than 20 mass %. The upper limit of the range in values for the dry rubber content of the natural rubber latex might, for example, be 60 mass % or 50 mass %.

It is preferred that the filler slurry and the natural rubber latex be combined so as to preferably cause there to be not less than 10 parts by mass, more preferably not less than 20 parts by mass, and still more preferably not less than 30 parts by mass, of filler per 100 parts by mass of dry rubber content in the natural rubber latex. It is preferred that the two be combined so as to preferably cause there to be not greater than 100 parts by mass, more preferably not greater than 90 parts by mass, more preferably not greater than 80 parts by mass, more preferably not greater than 70 parts by mass, and still more preferably not greater than 60 parts by mass, of filler per 100 parts by mass of dry rubber content in the natural rubber latex.

1.1.2. Operation A2 (Operation in which Agitation is Carried Out while Heating is Carried Out).

At Operation A2, the liquid prepared at Operation A1, i.e., a liquid prepared by causing one of filler slurry and natural rubber latex to be added to the other, is agitated as it is heated. By so doing, it is possible to cause mixture of the filler slurry and the natural rubber latex, which is to say that it is possible to these to be intermingled and it is possible to promote mutual coagulation of filler and rubber particles. To cause this liquid to be agitated as it is heated, it is preferred that a mixing tank which is equipped with agitator vane(s) be employed. Thereamong, a mixing tank having a mechanism that causes agitator vane(s) to rotate within cylindrical container(s) is preferred. As mixing tank equipped with agitator vane(s), the “Supermixer” manufactured by Kawata Co., Ltd., the “Supermixer” manufactured by Shinei-Kikai Co., Ltd., the “Universal Mixer” manufactured by Tsukishima Machine Sales Co., Ltd., and the “Henschel Mixer” manufactured by Nippon Coke & Engineering Co., Ltd., may be cited as examples.

At Operation A2, it is preferred that the amount of heat imparted to the liquid mixture as a result of heating, more specifically the amount of heat per unit time and per unit mass, be not less than 25 J. Causing this to be not less than 25 J will make it possible to promote mutual coagulation by means of thermal energy to a certain degree. On the other hand, it is preferred that such amount of heat be not greater than 250 J. Causing this to be not greater than 250 J will make it possible to suppress occurrence of a situation in which mutual coagulation might otherwise be made to proceed to an excessive degree. This will consequently make it possible to avoid worsening of filler dispersion characteristics such as might occur were mutual coagulation allowed to proceed to an excessive degree. Moreover, to cause such amount of heat be not less than 25 J but not greater than 250 J, it is for example preferred to employ an agitation time of 5 min to 60 min while heating is carried out at a heating temperature of 70° C. to 180° C., and more preferred to employ an agitation time of 10 min to 45 min while heating is carried out at a heating temperature of 80° C. to 160° C.

It is preferred that agitator vane circumferential speed be less than 10 m/s. Causing this to be less than 10 m/s will make it possible to suppress occurrence of a situation in which mutual coagulation might otherwise be made to proceed to an excessive degree. This will consequently make it possible to avoid worsening of filler dispersion characteristics such as might occur were mutual coagulation allowed to proceed to an excessive degree.

1.2. Operation B (Operation in which Coagulant is Added to Liquid Mixture)

At Operation B, coagulant is added to the liquid mixture so as to cause pH to be not less than 5.0 but less than 8.0. Because coagulant is added to the liquid mixture so as to cause the pH thereof to be not less than 5.0, efficient reduction of the water content of the coagulum is made possible. This is thought to be due to the fact that adding coagulant to the liquid mixture so as to cause pH to be not less than 5.0 causes the surface properties of the coagulum to be in such state as to possess suitable tackiness for compaction and kneading (e.g., a state in which there is suitable tackiness such as will permit suppression or reduction of slippage that might otherwise occur during the compaction and kneading which is carried out by an extruder), which consequently makes effective compaction and kneading of the coagulum possible. On the other hand, because coagulant is added to the liquid mixture so as to cause pH to be less than 8.0, it is possible to prevent tackiness of the coagulum from becoming excessively high, as a result of which it is possible, e.g., when the coagulum is subjected to treatment in an extruder, to prevent the inlet port of the extruder from being clogged by the coagulum.

At Operation B, it is preferred that coagulant be added to the liquid mixture so as to cause pH to be not less than 5.1. At Operation B, it is preferred that coagulant be added to the liquid mixture so as to cause pH to be less than 7.8, more preferred that coagulant be added thereto so as to cause pH to be less than 7.6, and still more preferred that coagulant be added thereto so as to cause pH to be less than 7.4.

So long as it is capable of lowering the pH of the liquid mixture, there is no particular limitation with regard to the coagulant. As coagulant, acid may be cited as an example. As acid, formic acid, sulfuric acid, and the like may be cited as examples. Addition of coagulant may be carried out while agitating the liquid mixture, may be carried out while heating the liquid mixture, or may be carried out in state(s) constituting any desired combination thereof (i.e., agitation and/or heating).

Following coagulation, the coagulum may be separated from waste liquid as necessary. The coagulum might, for example, take the form of small pieces. Note that coagulum in the form of small pieces is sometimes referred to as “crumbs.”

1.3. Operation C (Operation in which Coagulum is Dewatered)

At Operation C, the coagulum is dewatered. At Operation C, it is preferred that the coagulum, after being compacted, is plasticized as it is being dried.

An extruder, oven, vacuum dryer, and/or air dryer might, for example, be used to dewater the coagulum. Of these, an extruder is preferred. By using an extruder, it is possible, after compacting the coagulum, to carry out kneading thereof. That is, the coagulum, after being compacted, can be plasticized as it is being dried. As extruder, a single-screw extruder may be cited as an example.

It is preferred that the loss in weight due to heating following dewatering be not greater than 1.5 mass %, more preferred that this be not greater than 1.0 mass %, and still more preferred that this be not greater than 0.8 mass %. Note that measurement and calculation to determine the loss in weight due to heating may be carried out in accordance with the method described in the Working Examples.

### 1.4. Other Operations

The dewatered coagulum may be cut as necessary, and may be compressed and formed into any desired shape as necessary. A pelletizer might, for example, be used to carry out cutting of the coagulum.

The masterbatch thus obtained may take the form of bales. The form taken by the masterbatch is not limited to bales, it also being possible for it to take the form of sheets, for example.

The masterbatch comprises a rubber component that comprises natural rubber. The amount of natural rubber might, for example, be not less than 80 mass %, might be not less than 90 mass %, or might be 100 mass %, per 100 mass % of rubber component in the masterbatch.

The masterbatch may comprise filler. It is preferred that the amount of filler be not less than 10 parts by mass, more preferred that this be not less than 20 parts by mass, and still more preferred that this be not less than 30 parts by mass, per 100 parts by mass of rubber component. It is preferred that the amount of filler be not greater than 100 parts by mass, still more preferred that this be not greater than 90 parts by mass, still more preferred that this be not greater than 80 parts by mass, still more preferred that this be not greater than 70 parts by mass, and still more preferred that this be not greater than 60 parts by mass, per 100 parts by mass of rubber component.

The amount of carbon black might, for example, be not less than 20 mass %, might be not less than 40 mass %, might be not less than 60 mass %, might be not less than 80 mass %, or might be 100 mass %, per 100 mass % of filler in the masterbatch.

### 2. Tire Manufacturing Method

A tire manufacturing method in accordance with the present embodiment comprises an operation in which masterbatch is prepared in accordance with a method as described above, an operation in which the masterbatch is used to prepare a rubber composition, and an operation in which the rubber composition is used to prepare an unvulcanized tire.

2.1. Operation in which Masterbatch is Used to Prepare Rubber Composition

This operation (more specifically, an operation in which masterbatch is used to prepare a rubber composition) may comprise kneading at least masterbatch and compounding ingredient(s) to prepare a rubber mixture, and kneading at least the rubber mixture and vulcanizing-type compounding ingredient(s) to obtain a rubber composition.

At this operation (more specifically, an operation in which masterbatch is used to prepare a rubber composition), at least masterbatch and compounding ingredient(s) are kneaded to prepare a rubber mixture. As compounding ingredients, filler, zinc oxide, stearic acid, wax, antioxidant, silane coupling agent, vulcanizing-type compounding ingredient, and the like may be cited as examples. One or any desired combination may be chosen from thereamong and used as compounding ingredient(s). Note, however, that it is preferred that vulcanizing-type compounding ingredient not be added at this stage. As filler, carbon black, silica, clay, talc, calcium carbonate, magnesium carbonate, aluminum hydroxide, and the like may be cited as examples. One or any desired combination may be chosen from thereamong and used as the filler. As antioxidant, aromatic-amine-type antioxidant, amine-ketone-type antioxidant, monophenol-type antioxidant, bisphenol-type antioxidant, polyphenol-type antioxidant, dithiocarbamate-type antioxidant, thiourea-type antioxidant, and the like may be cited as examples. One or any desired combination may be chosen from thereamong and used as the antioxidant. Other rubber(s) may be kneaded therein together with the masterbatch and compounding ingredient(s). As such rubbers, natural rubber, polyisoprene rubber, styrene-butadiene rubber, nitrile rubber, chloroprene rubber, and the like may be cited as examples. One or any desired combination may be chosen from thereamong and used. Kneading may be carried out using a kneader. As the kneader, internal kneaders, open roll mills, and the like may be cited as examples. As an internal kneader, Banbury mixers, kneaders, and the like may be cited as examples.

At this operation (more specifically, an operation in which masterbatch is used to prepare a rubber composition), at least the rubber mixture and vulcanizing-type compounding ingredient(s) are kneaded to obtain a rubber composition. As vulcanizing-type compounding ingredients, sulfur, organic peroxides, and other such vulcanizing agents, vulcanization accelerators, vulcanization accelerator activators, vulcanization retarders, and so forth may be cited as examples. One or any desired combination may be chosen from thereamong and used as the vulcanizing-type compounding ingredient. As sulfur, powdered sulfur, precipitated sulfur, insoluble sulfur, high dispersing sulfur, and the like may be cited as examples. One or any desired combination may be chosen from thereamong and used as the sulfur. As vulcanization accelerators, sulfenamide-type vulcanization accelerators, thiuram-type vulcanization accelerators, thiazole-type vulcanization accelerators, thiourea-type vulcanization accelerators, guanidine-type vulcanization accelerators, dithiocarbamate-type vulcanization accelerators, and so forth may be cited as examples. One or any desired combination may be chosen from thereamong and used as the vulcanization accelerator. Kneading may be carried out using a kneader. As the kneader, internal kneaders, open roll mills, and the like may be cited as examples. As an internal kneader, Banbury mixers, kneaders, and the like may be cited as examples.

Thus, this operation (more specifically, an operation in which masterbatch is used to prepare a rubber composition) may comprise at least nonproductive kneading (nonproductive mixing) and productive kneading (productive mixing).

The rubber composition comprises rubber component originating from the masterbatch. The amount of rubber component originating from the masterbatch might be not less than 20 mass %, not less than 40 mass %, might be not less than 60 mass %, might be not less than 80 mass %, or might be 100 mass %, per 100 mass % of rubber component within the rubber composition, for example.

The rubber composition may comprise filler. It is preferred that the amount of filler be not less than 10 parts by mass, more preferred that this be not less than 20 parts by mass, and still more preferred that this be not less than 30 parts by mass, per 100 parts by mass of rubber component within the rubber composition. It is preferred that the amount of filler be not greater than 100 parts by mass, still more preferred that this be not greater than 90 parts by mass, still more preferred that this be not greater than 80 parts by mass, still more preferred that this be not greater than 70 parts by mass, and still more preferred that this be not greater than 60 parts by mass, per 100 parts by mass of rubber component within the rubber composition.

The amount of carbon black might, for example, be not less than 20 mass %, might be not less than 40 mass %, might be not less than 60 mass %, might be not less than 80 mass %, or might be 100 mass %, per 100 mass % of filler in the rubber composition.

The rubber composition may further comprise zinc oxide, stearic acid, wax, antioxidant, silica, silane coupling agent, sulfur, vulcanization accelerator, and/or the like. The rubber composition may comprise one or any desired combination thereamong. It is preferred that the amount of the sulfur, expressed as equivalent sulfur content, be 0.5 part by mass to 5 parts by mass, per 100 parts by mass of rubber component within the rubber composition. It is preferred that the amount of vulcanization accelerator be 0.1 part by mass to 5 parts by mass, per 100 parts by mass of rubber component within the rubber composition.

The rubber composition may be used to prepare a tire. More specifically, it is capable of being used in preparing tire member(s) making up a tire. For example, the rubber composition may be used in preparing tread rubber, sidewall rubber, chafer rubber, bead filler rubber, and/or the like. The rubber composition may be used to prepare one or any desired combination among such tire member(s).

2.2. Operation in which Rubber Composition is Used to Prepare Unvulcanized Tire

A tire manufacturing method in accordance with the present embodiment comprises an operation in which a rubber composition is used to prepare an unvulcanized tire. This operation may comprise preparing tire member(s) comprising a rubber composition, and preparing an unvulcanized tire comprising the tire member(s). As tire members, tread rubber, sidewall rubber, chafer rubber, and bead filler rubber may be cited as examples.

### 2.3. Other Operations

A tire manufacturing method in accordance with the present embodiment may further comprise an operation in which the unvulcanized tire is vulcanized and molded. The tire obtained in accordance with the method of the present embodiment may be a pneumatic tire.

### 3. Various Modifications May be Made to the Foregoing Embodiment

Various modifications may be made to the foregoing embodiment. For example, modifications which may be made to the foregoing embodiment might include any one or more variations chosen from among the following.

The foregoing embodiment was described in terms of a constitution in which water is used to prepare a filler slurry. However, the foregoing embodiment is not limited to this constitution. For example, dilute rubber latex may be used instead of water. More specifically, a filler slurry might be prepared through employment of a procedure in which filler is added to dilute rubber latex, and this is agitated. In the dilute rubber latex, rubber particles may be dispersed in colloidal fashion in water. The water might, for example, be water that contains organic solvent. It is preferred that dry rubber content of the dilute rubber latex be not less than 0.1 mass %, and more preferred that this be not less than 0.3 mass %. It is preferred that the upper limit of the range in values for the dry rubber content be 5 mass %, and more preferred that this be 2 mass %. The dilute rubber latex might, for example, be prepared through employment of a procedure in which natural rubber latex is diluted with water. Synthetic rubber latex may be used instead of natural rubber latex.

The foregoing embodiment was described in terms of a constitution in which Operation A2 is an operation in which a liquid prepared by causing one of filler slurry and natural rubber latex to be added to the other is agitated as it is heated. However, the foregoing embodiment is not limited to this constitution. For example, Operation A2 might be an operation in which that liquid (i.e., a liquid prepared by causing one of filler slurry and natural rubber latex to be added to the other) is agitated without being heated.

The foregoing embodiment was described in terms of a constitution in which the tire is a pneumatic tire. However, the foregoing embodiment is not limited to this constitution.

### WORKING EXAMPLES

Working examples in accordance with the present invention are described below. Hereinbelow, note that masterbatch is sometimes referred to as “MB”.

The raw materials and reagents that were used at the Working Examples are indicated below.
Concentrated natural rubber latex (dry rubber content=31.2%; Mw=232,000) Manufactured by Golden Hope
Carbon black “SEAST 9” manufactured by Tokai Carbon Co., Ltd.

### Preparation of Masterbatch at the Various Examples

Water was added to concentrated natural rubber latex manufactured by Golden Hope to prepare a dilute natural rubber latex having a dry rubber content of 0.5 mass %, and a natural rubber latex having a dry rubber content of 25 mass %. Carbon black was added to this dilute natural rubber latex, and an agitator (Flashblend) manufactured by Silverson was used to carry out agitation at 3600 rpm for 30 minutes to prepare a carbon black slurry (hereinafter, this operation is sometimes referred to as “Operation (I)”). The natural rubber latex having the dry rubber content of 25 mass % was added to this carbon black slurry in accordance with TABLE 1 (that is, natural rubber latex was added to carbon black slurry so as to produce the blended amounts in TABLE 1), and a mixer (SMV-20 Supermixer) manufactured by Kawata Co., Ltd., was used to carry out agitation as this was heated in accordance with the conditions shown in TABLE 1 (hereinafter, this operation is sometimes referred to as “Operation (II)”). Next, as the liquid mixture was made to undergo agitation, coagulant—more specifically, a 10 mass % aqueous solution (pH 1.2) of formic acid—was added to the liquid mixture in a quantity sufficient to cause the pH to be value shown in TABLE 1 (hereinafter, this operation is sometimes referred to as “Operation (III)”). The coagulum formed as a result hereof was separated from the coagulation liquid (i.e., waste liquid). A squeezer-type single-screw dewatering extruder (Model V-02 screw press manufactured by Suehiro EPM Corporation) was used to dewater the coagulum at 200° C. That is, after the coagulum was made to undergo compaction by the squeezer-type single-screw dewatering extruder, it was plasticized as it was made to undergo drying at 200° C. Masterbatch was obtained as a result of such procedure.

### Loss in Weight Due to Heating

As an index of the efficiency with which water was content was reduced, loss in weight due to heating of the coagulum following dewatering, i.e., loss in weight due to heating of the masterbatch, was evaluated. More specifically, an MX-50 heating-and-drying-type moisture analyzer manufactured by A&D Company, Limited, was used to measure the loss in weight due to heating of masterbatch in accordance with JIS K 6238-2. In other words, the volatile component was measured in accordance with JIS K 6238-2. The lower the loss in weight due to heating the lower the water content of the coagulum following dewatering, i.e., the water content of the masterbatch.

Loss in weight due to heating={(mass of MB before heating−mass of MB after heating)/(mass of MB before heating)}×100

### Clogging of Inlet Port

Whether clogging occurred at the inlet port when a squeezer-type single-screw dewatering extruder was operated for 20 minutes was recorded.

TABLE 1

| | | | | | |
|---|---|---|---|---|---|
| Comparative | Working | Working | Comparative | Comparative | Working |
| Example 1 | Example 1 | Example 2 | Example 2 | Example 3 | Example 3 |

Blended amount

| | | | | | | | |
|---|---|---|---|---|---|---|---|
| Component blended in MB | Carbon black | 50 | 50 | 50 | 50 | 40 | 40 |
| | Natural rubber (dry rubber content) | 100 | 100 | 100 | 100 | 100 | 100 |

Various conditions at Operation (II) and Operation (III)

| | | | | | | |
|---|---|---|---|---|---|---|
| Agitation time (minutes) while carrying out heating at Operation (II) | 30 | 30 | 30 | 30 | 30 | 30 |
| Heating temperature (° C.) at Operation (II) | 150 | 150 | 150 | 150 | 150 | 150 |
| pH of coagulation liquid following addition of acid at Operation (III) | 4.2 | 5.2 | 6.9 | 8.5 | 4.0 | 5.1 |
| Agitator vane circumferential speed (m/s) at Operation (II) | 9 | 9 | 9 | 9 | 9 | 9 |
| Amount of heat at Operation (II) | 47 | 47 | 47 | 47 | 47 | 47 |

Evaluation

| | | | | | | |
|---|---|---|---|---|---|---|
| Loss in weight due to heating (%) | 2.5 | 0.4 | 0.4 | — | 3.2 | 0.4 |
| Clogging of inlet port | No | No | No | Yes | No | No |

| | | | | | |
|---|---|---|---|---|---|
| Working | Comparative | Comparative | Working | Working | Comparative |
| Example 4 | Example 4 | Example 5 | Example 5 | Example 6 | Example 6 |

Blended amount

| | | | | | | | |
|---|---|---|---|---|---|---|---|
| Component blended in MB | Carbon black | 40 | 40 | 30 | 30 | 30 | 30 |
| | Natural rubber (dry rubber content) | 100 | 100 | 100 | 100 | 100 | 100 |

Various conditions at Operation (II) and Operation (III)

| | | | | | | |
|---|---|---|---|---|---|---|
| Agitation time (minutes) while carrying out heating at Operation (II) | 30 | 30 | 30 | 30 | 30 | 30 |
| Heating temperature (° C.) at Operation (II) | 150 | 150 | 150 | 150 | 150 | 150 |
| pH of coagulation liquid following addition of acid at Operation (III) | 7.2 | 8.6 | 4.3 | 5.4 | 7.2 | 8.5 |
| Agitator vane circumferential speed (m/s) at Operation (II) | 9 | 9 | 9 | 9 | 9 | 9 |
| Amount of heat at Operation (II) | 47 | 47 | 47 | 47 | 47 | 47 |

Evaluation

| | | | | | | |
|---|---|---|---|---|---|---|
| Loss in weight due to heating (%) | 0.3 | — | 4.0 | 0.5 | 0.3 | — |
| Clogging of inlet port | No | Yes | No | No | No | Yes |

Supplemental explanation is given regarding TABLE 1.

“Heating temperature at Operation (II)” is the heating temperature, i.e., the temperature at the end of agitation at Operation (II).

“Amount of heat at Operation (II)” is the amount of heat per unit time and per unit mass which is imparted to the liquid mixture as a result of heating at Operation (II). The amount of this heat was calculated using the following formula.

Amount of heat=(temperature at end of agitation [K]−temperature at start of agitation [K])×specific heat [J/kg·K]/agitation time [sec]

Note that where “−” is entered for the loss in weight due to heating, this indicates that measurement was not carried out.

At Comparative Example 1, where coagulant was added in sufficient quantity to cause pH to be 4.2, the loss in weight due to heating was 2.5%. On the other hand, at Working Example 1, where coagulant was added in sufficient quantity to cause pH to be 5.2, the loss in weight due to heating was a mere 0.4%. And at Working Example 2 as well, where coagulant was added in sufficient quantity to cause pH to be 6.9, the loss in weight due to heating was a mere 0.4%. At Comparative Example 2, where coagulant was added in sufficient quantity to cause pH to be 8.5, there was occurrence of clogging at the inlet port. This is thought to be due to the fact that tackiness of the coagulum prepared at Comparative Example 2 was greater than that of the other examples (i.e., Comparative Example 1, Working Example 1, and Working Example 2).

Loss in weight due to heating was less at Working Examples 3 and 4, where coagulant was added in sufficient quantity to cause pH to be 5.1 and 7.2, than at Comparative Example 3, where coagulant was added in sufficient quantity to cause pH to be 4.0. At Comparative Example 4, where coagulant was added in sufficient quantity to cause pH to be 8.6, there was occurrence of clogging at the inlet port. This is thought to be due to the fact that tackiness of the coagulum prepared at Comparative Example 4 was greater than that of the other examples (i.e., Comparative Example 3, Working Example 3, and Working Example 4).

Loss in weight due to heating was less at Working Examples 5 and 6, where coagulant was added in sufficient quantity to cause pH to be 5.4 and 7.2, than at Comparative Example 5, where coagulant was added in sufficient quantity to cause pH to be 4.3. At Comparative Example 6, where coagulant was added in sufficient quantity to cause pH to be 8.5, there was occurrence of clogging at the inlet port. This is thought to be due to the fact that tackiness of the coagulum prepared at Comparative Example 6 was greater than that of the other examples (i.e., Comparative Example 5, Working Example 5, and Working Example 6).

1. A masterbatch manufacturing method, comprising:
an operation in which at least a filler slurry and a natural rubber latex are mixed to prepare a liquid mixture; and
an operation in which a coagulant is added to the liquid mixture so as to cause pH to be not less than 5.0 but less than 8.0.

2. The masterbatch manufacturing method according to claim 1 wherein the filler slurry comprises carbon black.

3. The masterbatch manufacturing method according to claim 1 wherein, at the operation in which the coagulant is added to the liquid mixture, the coagulant is added to the liquid mixture so as to cause pH to be not less than 5.1.

4. The masterbatch manufacturing method according to claim 1 wherein, at the operation in which the coagulant is added to the liquid mixture, the coagulant is added to the liquid mixture so as to cause pH to be less than 7.8.

5. The masterbatch manufacturing method according to claim 1 wherein, at the operation in which the coagulant is added to the liquid mixture, the coagulant is added to the liquid mixture so as to cause pH to be less than 7.6.

6. The masterbatch manufacturing method according to claim 1 wherein, at the operation in which the coagulant is added to the liquid mixture, the coagulant is added to the liquid mixture so as to cause pH to be less than 7.4.

7. The masterbatch manufacturing method according to claim 1 wherein the coagulant is acid.

8. The masterbatch manufacturing method according to claim 1 wherein, at the operation in which the liquid mixture is prepared, the filler slurry and the natural rubber latex are combined so as to cause there to be not less than 10 parts by mass but not greater than 100 parts by mass of filler in the filler slurry per 100 parts by mass of dry rubber content in the natural rubber latex.

9. The masterbatch manufacturing method according to claim 1 wherein, at the operation in which the liquid mixture is prepared, the filler slurry and the natural rubber latex are combined so as to cause there to be not less than 20 parts by mass but not greater than 90 parts by mass of filler in the filler slurry per 100 parts by mass of dry rubber content in the natural rubber latex.

10. The masterbatch manufacturing method according to claim 1 wherein, at the operation in which the liquid mixture is prepared, the filler slurry and the natural rubber latex are combined so as to cause there to be not less than 30 parts by mass but not greater than 80 parts by mass of filler in the filler slurry per 100 parts by mass of dry rubber content in the natural rubber latex.

11. The masterbatch manufacturing method according to claim 1 further comprising:
an operation in which an extruder is used to dewater a coagulum obtained by coagulation of the liquid mixture.

12. A tire manufacturing method comprising:
an operation in which a masterbatch is prepared by the masterbatch manufacturing method according to claim 1;
an operation in which the masterbatch is used to prepare a rubber composition; and
an operation in which the rubber composition is used to prepare an unvulcanized tire.

13. The tire manufacturing method according to claim 12 wherein
the operation in which the rubber composition is prepared comprises kneading at least the masterbatch and a compounding ingredient to prepare a rubber mixture, and kneading at least the rubber mixture and sulfur to obtain the rubber composition.
